(19) United States
(12) Patent Application Publication
(10) Pub. No.: US 2009/0324213 A1
(43) Pub. Date: Dec. 31, 2009

(54) IMAGE CAPTURE ASSEMBLY

(75) Inventor: SHAO-HUNG WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/202,333

(22) Filed: Sep. 1, 2008

(30) Foreign Application Priority Data
Jun. 30, 2008 (CN) 200810302458.7

(51) Int. Cl. G03B 17/02; G03B 17/00; H04N 5/225

(52) U.S. Cl. 396/529; 396/535; 348/373; 348/E05.024

(57) ABSTRACT

An image capture assembly is disclosed. The image capture assembly includes a housing, a lens unit, an image detection unit, three screws, and three elastic members. The housing includes a lens-receiving portion, and three screw-receiving portions on an inner surface of the housing and surrounding the lens-receiving portion, an end surface of each screw-receiving portion defining a threaded hole. The lens unit is received in the lens-receiving portion. The image detection unit includes a substrate and an image sensor. The substrate facing the inner surface of the housing defines three through holes therein aligned with the three screw-receiving portions respectively. The image sensor is fixed to the substrate and faces the lens-receiving portion. The screws extend through the through holes of the substrate and into the threaded holes of the screw-receiving portions respectively. The elastic members surround the screw-receiving portions respectively and are compressed between the housing and the substrate.

### BACKGROUND

1. Technical Field

The invention relates to image capture devices and, more particularly, to an image capture assembly moving an image sensor thereof relative to a lens thereof.

2. Description of the Related Art

Usually, image capture devices include a lens and an image sensor. To ensure image quality, an optical axis of the lens must be perpendicular to a light-receiving surface of the image sensor and pass through the central point of the light-receiving surface. In reality, deviations from such requirement are common. Therefore, tests for whether the image capture devices satisfy the requirement and, sometimes, sequential repositioning are required. To eliminate the deviation, washers are employed to reposition the image sensor. When deviation is detected after assembly, the image capture device must be disassembled to interpose the washer(s). This prolongs assembly.

Therefore, it is desirable to provide an image capture assembly, which can overcome the described limitation.

### SUMMARY

An image capture assembly is disclosed. The image capture assembly includes a housing, a lens unit, an image detection unit, three screws, and three elastic members. The housing includes a lens-receiving portion, and three screw-receiving portions on an inner surface of the housing and surrounding the lens-receiving portion, an end surface of each screw-receiving portion defining a threaded hole. The lens unit is received in the lens-receiving portion. The image detection unit includes a substrate and an image sensor. The substrate facing the inner surface of the housing defines three through holes therein aligned with the three screw-receiving portions respectively. The image sensor is fixed to the substrate and faces the lens-receiving portion. The screws extend through the through holes of the substrate and into the threaded holes of the screw-receiving portions respectively. The elastic members surround the screw-receiving portions respectively and are compressed between the housing and the substrate.

### BRIEF DESCRIPTION OF THE DRAWINGS

Many aspects of the present image capture assembly should be better understood with reference to the following drawings. The components in the drawings are not necessarily drawn to scale, the emphasis instead being placed upon clearly illustrating the principles of the present image capture assembly. Moreover, in the drawings, like reference numerals designate corresponding parts throughout the several views.

FIG. 1 is an isometric, exploded view of an image capture assembly including a housing, according to a first exemplary embodiment.

FIG. 2 is an isometric view of the housing of FIG. 1.

FIG. 3 is a cross-section of the image capture assembly of FIG. 1.

### DETAILED DESCRIPTION OF EMBODIMENTS

Embodiments of the present image capture assembly will now be described in detail with references to the drawings.

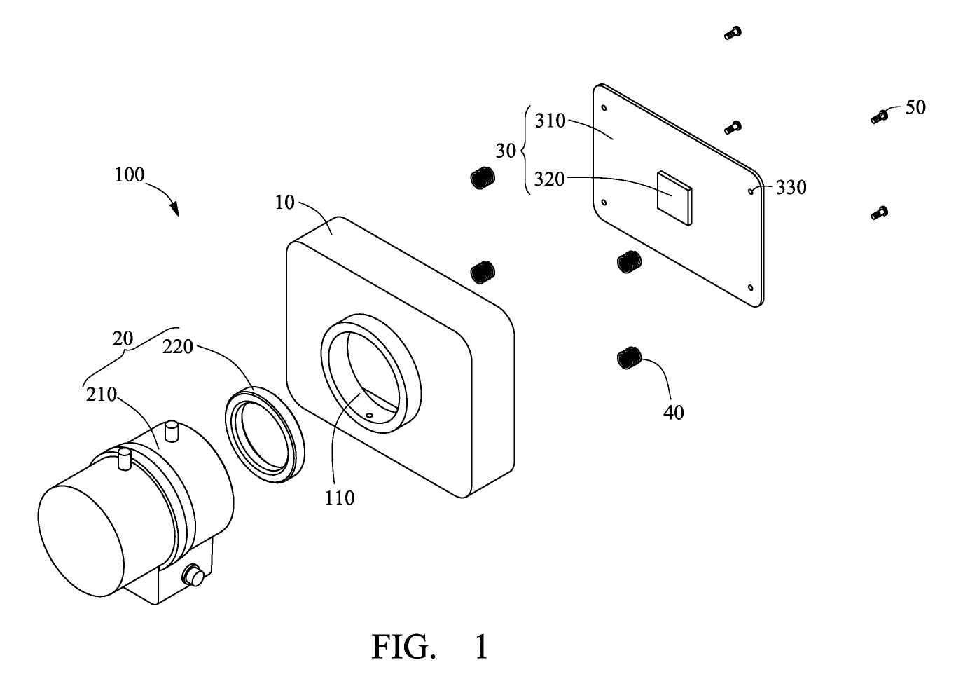

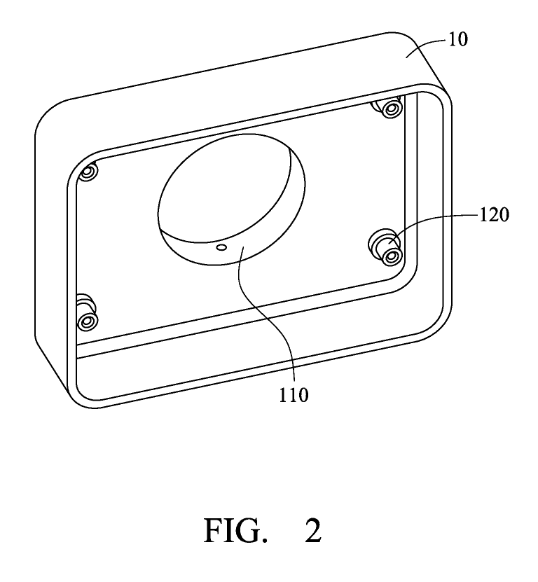

Referring to FIG. 1 and FIG. 2, an image capture assembly 100 includes a housing 10, a lens unit 20, an image detection unit 30, four screws 50, and four elastic members 40.

The housing 10 includes a lens-receiving portion 110 and four screw-receiving portions 120. The lens-receiving portion 110 is a first tube extending outward from the outer surface of the housing 10. The four screw-receiving portions 120 are four second tubes protruding inward from the inner surface of the housing 10 and surrounding the lens-receiving portion 110. One end surface of each of the four screw-receiving portions 120 defines a threaded hole.

The lens unit 20 includes a lens barrel 210 and a lens ring 220, mounted on the lens-receiving portion 110 of the housing 10. The lens barrel 210 is fixed to the lens ring 220 and includes at least one lens. In this embodiment, the lens barrel 210 and the lens ring 220 are assembled together. However, in other embodiments, the lens barrel 210 can be directly assembled into the lens-receiving portion 110 of the housing 10 without the lens ring 220.

The image detection unit 30 includes a substrate 310 and an image sensor 320. The substrate 310 faces the inner surface of the housing 10 and defines four through holes 330 therein. The four through holes 330 are respectively aligned with the threaded holes of the four screw-receiving portions 120. The substrate 310 can be fixed to the housing 10 by extending the screws 50 through the through holes 330 and the threaded holes of the four screw-receiving portions 120. The image sensor 320, such as a Complementary Metal-Oxide-Semiconductor (CMOS) image sensor, is electrically coupled to the substrate 310 and substantially aligned with the lens-receiving portion 110.

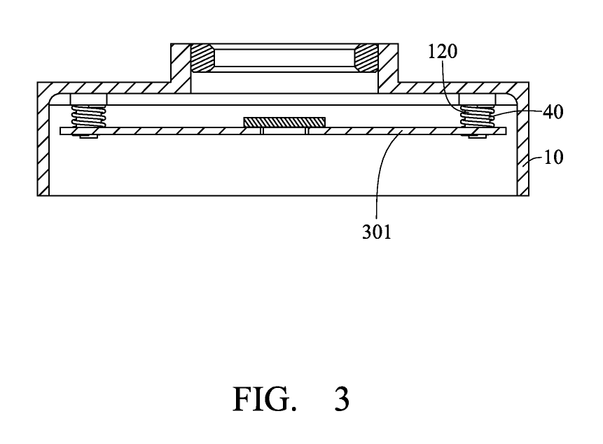

Referring to FIG. 3, each of the elastic members 40, such as a coil spring, is sleeved on one of the screw-receiving portions 120 respectively. The elastic members 40 are longer than the four screw-receiving portions 120. The substrate 310 is fixed to the housing 10 by the screws 50 passing through holes 330 and into the four screw-receiving portions 120 respectively. Therefore, the elastic members 40 are compressed between the housing 10 and the substrate 310. It should be understood that the number of screw-receiving portions, holes, screws, and elastic members are not limited by this embodiment, but can be three, four, or more.

An included angle between the light-sensing surface of the image sensor and the optical axis of the lens unit 20 can be adjusted by tightening or loosening a corresponding screw 50, thereby aligning the image sensor 320 and the lens unit 20 without needing to separate the image detection unit 30 from the image capture assembly 100. Efficiency of assembly is thus increased.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An image capture assembly, comprising:
a housing comprising a lens-receiving portion, and three screw-receiving portions on an inner surface of the housing and surrounding the lens-receiving portion, an end surface of each screw-receiving portion defining a threaded hole;
a lens unit received in the lens-receiving portion;
an image detection unit comprising:
a substrate facing the inner surface of the housing and defining three through holes therein aligned with the three screw-receiving portions respectively; and
an image sensor fixed to the substrate and facing the lens-receiving portion;
three screws extended through the three through holes of the substrate and into the threaded holes of the three screw-receiving portions respectively; and
three elastic members surrounding the three screw-receiving portions respectively and compressed between the housing and the substrate.

2. The image capture assembly of claim 1, wherein the lens unit comprises a lens barrel, and a lens ring mounted on the lens-receiving portion, the lens barrel being attached to the lens ring.

3. The image capture assembly of claim 1, wherein the image sensor substantially aligns with the lens-receiving portion.

4. The image capture assembly of claim 1, wherein the image sensor is a complementary metal-oxide-semiconductor image sensor.

5. The image capture assembly of claim 1, wherein the elastic members are coil springs.

6. An image capture assembly, comprising:
a housing comprising a lens-receiving portion, and three or more screw-receiving portions on an inner surface of the housing and surrounding the lens receiving portion, an end surface of each screw-receiving portion defining a threaded hole;
an image detection unit comprising:
a substrate facing the inner surface of the housing and defining three or more through holes therein aligned with the screw-receiving portions respectively; and
an image sensor fixed to the substrate and facing the lens-receiving portion;
three or more screws extended through the through holes and received in the threaded holes of the screw-receiving portions respectively; and
three or more elastic members surrounding the screw-receiving portions respectively and compressed between the housing and the substrate.

7. The image capture assembly of claim 6, wherein the lens-receiving portion is configured for receiving a lens unit.

8. The image capture assembly of claim 6, wherein the lens unit comprises a lens barrel and a lens ring, the lens-receiving portion receiving the lens ring and the lens barrel attached to the lens ring.

9. The image capture assembly of claim 6, wherein the image sensor substantially aligns with the lens-receiving portion.

10. The image capture assembly of claim 6, wherein the image sensor is a complementary metal-oxide-semiconductor image sensor.

11. The image capture assembly of claim 6, wherein the elastic members are coil springs.
